(19) United States
(12) Patent Application Publication
(10) Pub. No.: US 2014/0124554 A1
(43) Pub. Date: May 8, 2014

(54) Little Green Hen (TM) Emergency Medical Alert Seat Belt Wrap

(71) Applicant: Carolyn Rae Van Kort, Coos Bay, OR (US)

(72) Inventor: Carolyn Rae Van Kort, Coos Bay, OR (US)

(21) Appl. No.: 13/670,264

(22) Filed: Nov. 6, 2012

(51) Int. Cl. B60R 7/04

(52) U.S. Cl. CPC B60R 7/04
USPC 224/539

(57) ABSTRACT

The Little Green Hen® Emergency Medical Alert Seat Belt Wrap is a fitted fabric rectangle with a front facing pocket that wraps around the shoulder section of Type 2 integral lap/shoulder safety belts in motor vehicles and is secured with hook and loop closure. The pocket has a white rectangular patch with rounded corners bordered in red surrounding the acronym ICE (In Case of Emergency) in red letters. ICE has been used since 2005 as a method of programming emergency contacts into cell phones. The pocket holds a plastic sleeve containing Medical and ICE Emergency Contact information that Emergency Responders can quickly access. Additionally, the pocket has a length of reflective fabric tape in the shape of a triangle stitched immediately above the ICE patch. In low light conditions, flashlights will reflect from the triangle and serve as an additional alert to responders.

### BACKGROUND OF THE INVENTION

Driving and riding in motor vehicles involves risk. In addition to road hazards and drunk drivers, the increasing number of distracted drivers texting on cell phones present dangers to themselves and others on the road. I invented the Little Green Hen® Emergency Medical Alert Seat Belt Wrap as an accessory added to the seat belt harness not only as a reminder to buckle-up but to possibly save lives by having medical and emergency contact information immediately accessible to Emergency Responders in the event of an accident. Frequently, First Responders such as fire and police cannot quickly locate identification for vehicle occupants. Precious time is lost while searching for identification and emergency contact information in glove compartment or purse, wallet or cell phone, which may have been thrown from the vehicle or damaged. Emergency Medical Technicians must act quickly to treat injuries resulting from trauma, particularly if occupant is unconscious and unable to respond, or if occupant is incoherent or experiencing disorientation from low blood sugar due to diabetes. The ICE designator patch and reflective fabric tape triangle on the pocket alert emergency responders to the headline MEDICAL Emergency Contact on the card in the plastic sleeve protruding from the top of the pocket. Card slides out of plastic sleeve and contains information filled in by the user with pertinent information regarding identity and ICE emergency contacts as well as medical conditions, medications and allergies. Headline at the top of the provided card can be either generic MEDICAL Emergency Contact or indicate a specific major condition such as DIABETIC, ASTHMA, CARDIAC, etc. as the user specifies. When occupants change seats in the vehicle, the seat belt wrap need not be removed; the plastic sleeves containing the cards can be slipped out and switched to the appropriate pocket.

### BRIEF SUMMARY OF THE INVENTION

The combined elements of ICE designator patch, reflective fabric tape triangle and MEDICAL Emergency Contact card contained in the plastic sleeve in the front pocket of the seat belt wrap can increase the chances of injured occupants receiving proper treatment in a timely manner. Additionally, with ICE contacts in hard copy form on the card, if occupant has a cell phone and it is damaged, not available or password protected, Emergency Responders can have the information in hand on the card. To encourage occupants to wear the ICE seat belt wraps, a variety of fabrics comprising the outer shell and pocket are used and range from cotton, polyester fleece, canvas, rip-stop polyester and nylon. Fabrics may be solid colors or printed patterns.

### BRIEF DESCRIPTION OF THE SEVERAL VIEWS OF THE DRAWING

FIG. 1 Depicts the front of the seat belt wrap as folded around the seat belt harness with the pocket facing outward from occupant's chest. ICE designator patch, reflective fabric tape triangle and MEDICAL Emergency Contact are immediately in view. Visible stitches are indicated with dotted lines.

FIG. 1A Stitches for shape retention.

FIG. 1B Folds

FIG. 1C Plastic sleeve containing MEDICAL Emergency Contact information card

FIG. 1D Pocket

FIG. 1E Reflective fabric tape triangle

FIG. 1F ICE designator patch

FIG. 1G Outer shell

FIG. 2 Depicts the front outer shell 8 inches high×6 inches wide, open and flat (outward facing) view.

FIG. 2A Stitches for shape retention.

FIG. 2G Outer shell

FIG. 2H Stitches securing hook strip on liner side

FIG. 2C Plastic sleeve containing MEDICAL Emergency Contact information card

FIG. 2D Pocket

FIG. 2E Reflective fabric tape triangle

FIG. 2F ICE designator patch

FIG. 2I Loop strip

FIG. 2J Product tag

FIG. 3 Depicts cross section view from the bottom width of outer shell 6 inches wide×½ inch high.

FIG. 3G Outer shell

FIG. 3K Fill

FIG. 3L Liner

FIG. 3J Product tag

FIG. 4 Depicts the back liner, open and flat view.

FIG. 4A Stitches for shape retention

FIG. 4J Product tag

FIG. 4M Stitches securing loop strip on outer shell side

FIG. 4L Liner

FIG. 4N Hook strip

FIG. 5 Depicts folded (chest facing) back view.

FIG. 5A Stitches for shape retention

FIG. 5B Fold

FIG. 5O Stitches securing hook strip on outer shell side

FIG. 5G Outer shell

FIG. 6 Depicts representational occupant with seat belt wrap installed.

FIG. 6P Little Green Hen® Emergency Medical Alert Seat Belt Wrap installed on seat belt harness and positioned just below shoulder

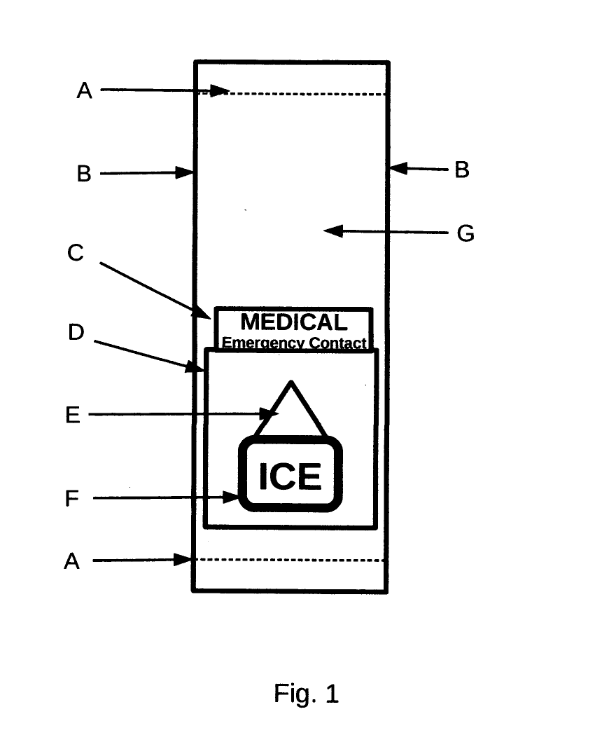

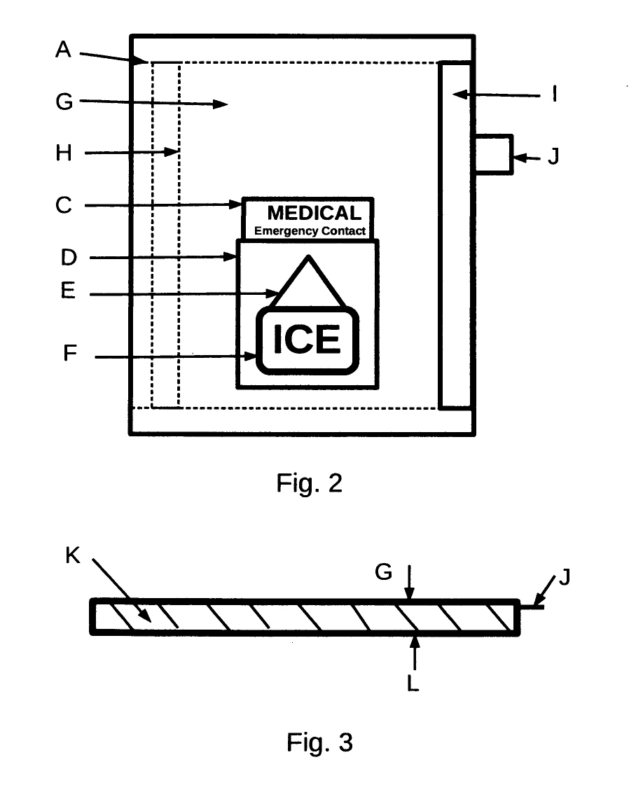

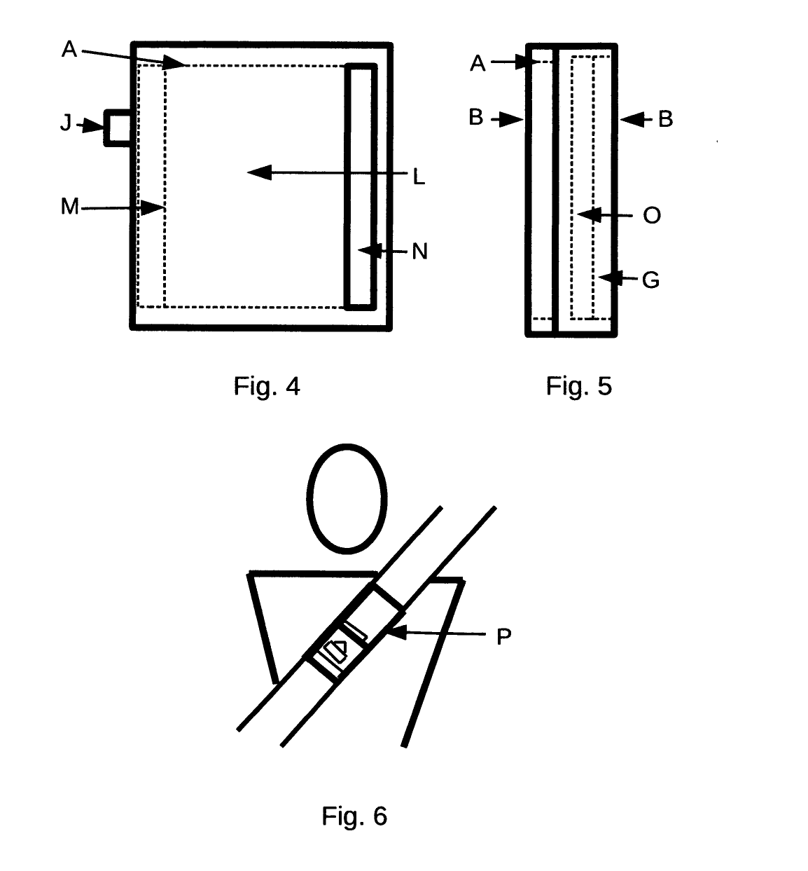

### DETAILED DESCRIPTION OF THE INVENTION

The Little Green Hen® Emergency Medical Alert Seat Belt Wrap is a fitted fabric rectangle with a pocket containing emergency contact and medical information. Apparatus folds around the shoulder harness section of Type 2 safety belts in a motor vehicle and is secured with hook and loop closure. To install on seat belt harness, user wraps apparatus lengthwise around seat belt harness and secures with hook and loop closure toward the chest and may be worn at any point on the harness section of the seat belt. User can easily remove apparatus for cleaning by separating hook and loop. Apparatus is composed of two fabric layers separated by polyester quilt batting fill for shape retention, in the form of a rectangle 8 inches high×6 inches wide when opened flat and 2 ¾ inches wide when when wrapped around standard 2 inch width seat belt shoulder harness. The outside shell is constructed from fabric, forming the outer layer. Polyester quilt batting fill retains shape and fabric is used for the liner. A strip of the loop half of hook and loop fastener is straight stitched to the shell front lengthwise right side edge and a strip of the hook half of the hook and loop fastener is straight stitched ½ inch from the lengthwise right edge of the liner. A line of straight stitches is sewn ½ inch from both the top and bottom width edges to further secure polyester fill when apparatus is machine washed and tumble dried. A separate rectangular piece of fabric 3 ¼ inches high×3 inches wide forms the pocket which is straight stitched on three sides, centering it in the lower half of the outer shell with open end at the top. The pocket has a 1 inch high×2 inches wide piece of reflective fabric tape in the shape of a triangle centered above a rectangular white patch 2 inches wide×1 ½ inches high bordered in red and enclosing the acronym ICE (In Case of Emergency) in red letters. The reflective tape enhances visibility to Emergency Responders. The provided plastic sleeve protrudes ¾ inch at the top of the pocket and accommodates a 4 inch high×2 inch wide card with the words “Emergency Medical Information” (or other pertinent designator) visible and which may contain contact and medical information at the user's discretion. During apparatus assembly, the tag consisting of the Little Green Hen trademark and “Made in the U.S.A.” (when American-made components are available) on one side and fabric composition and cleaning instructions on the flip side, is stitched between the fabric of the outer shell and the loop strip on the outward edge of the shell.

1. I claim that a need exists for emergency responders to vehicular accidents to quickly identify occupants and to have immediate access to medical and emergency contact information: The pocket on my seat belt wrap contains this information on a card in a removable plastic sleeve and bears a patch with the widely recognized acronym ICE (In Case of Emergency) and triangular reflective fabric tape for low light conditions.
